(19) United States
(12) Patent Application Publication
(10) Pub. No.: US 2014/0358516 A1
(43) Pub. Date: Dec. 4, 2014

(54) REAL-TIME, BI-DIRECTIONAL TRANSLATION

(71) Applicants: Yu-Kuan Lin, Taipei (TW); Hung-Ying Tyan, Taipei (TW); Chung-Yih Wang, Taipei (TW)

(72) Inventors: Yu-Kuan Lin, Taipei (TW); Hung-Ying Tyan, Taipei (TW); Chung-Yih Wang, Taipei (TW)

(73) Assignee: Google Inc., Mountain View, CA (US)

(21) Appl. No.: 13/542,190

(22) Filed: Jul. 5, 2012

Related U.S. Application Data
(60) Provisional application No. 61/540,877, filed on Sep. 29, 2011.

(51) Int. Cl. G06F 17/28

(52) U.S. Cl. 704/2

(57) ABSTRACT

Methods, systems, and apparatus, including computer programs encoded on a computer-readable storage medium, that include receiving a first audio signal from a first client communication device. A transcription of the first audio signal is then generated. Next, the transcription is translated. Then a second audio signal is generated from the translation. And then the following are communicated to a second client communication device: (i) the first audio signal received from the first device; and (2) the second audio signal generated from the translation of the transcription of the first audio signal received from the first client communication device.

### CROSS-REFERENCE TO RELATED APPLICATIONS

This application claims priority to U.S. Provisional Application Ser. No. 61/540,877, filed on Sep. 29, 2011, which is incorporated herein by reference in its entirety.

### BACKGROUND

This specification generally relates to the automated translation of speech.

Speech processing is a study of speech signals and the processing related to speech signals. Speech processing may include speech recognition and speech synthesis. Speech recognition is a technology which enables, for example, a computing device to convert an audio signal that includes spoken words to equivalent text. Speech synthesis includes converting text to speech. Speech synthesis may include, for example, the artificial production of human speech, such as computer-generated speech.

### SUMMARY

In general, one innovative aspect of the subject matter described in this specification can be embodied in methods that include the actions of monitoring a telephone call and translating the speech of a speaker, and overlaying synthesized speech of the translation in the same audio stream as the original speech. In this manner, if the listener does not speak the same language as the speaker, the listener can use the translation to understand and communicate with the speaker, while still receiving contextual clues, such as the speaker's word choice, inflexion and intonation, that might otherwise be lost in the automated translation process.

In general, another innovative aspect of the subject matter described in this specification can be embodied in methods that include receiving a first audio signal from a first client communication device. A transcription of the first audio signal is then generated. Next, the transcription is translated. Then a second audio signal is generated from the translation. And then the following are communicated to a second client communication device: (i) the first audio signal received from the first device; and (2) the second audio signal generated from the translation of the transcription of the first audio signal received from the first client communication device.

Other embodiments of this aspect include corresponding systems, apparatus, and computer programs, configured to perform the actions of the methods, encoded on computer storage devices.

These and other embodiments can each optionally include one or more of the following features. In some embodiments, the data identifying a language associated with the first audio signal from the first client communication device is received. In some embodiments, data identifying a language associated with the second audio signal from the first client communication device is received.

In certain embodiments, communicating the first audio signal and the second audio signal involves sending the first audio signal, and sending the second audio signal while the first audio signal is still being sent.

In some embodiments, a telephone connection between the first client communication device and the second client communication device is established. Some embodiments involve receiving from the first client communication device a signal indicating that the first audio signal is complete. Further, the transcription of the first audio signal is generated only after receiving the signal indicating that the first audio signal is complete.

Certain embodiments involve automatically determining a first language associated with the first audio signal and a second language associated with the second audio signal. The transcription is generated using a language model associated with the first language, and the transcription is translated between the first language and the second language. Furthermore, the second audio signal is generated using a speech synthesis model associated with the second language.

Certain embodiments include automatically determining a first language associated with a first portion of the first audio signal, a second language associated with a second portion of the first audio signal, and a third language associated with the second audio signal. The transcription of the first portion of the first audio signal is generated using a language model associated with the first language, and the transcription of the second portion of the first audio signal is generated using a language model associated with the second language. Also, the transcription of the first portion of the first audio signal is translated between the first language and the third language, and the transcription of the second portion of the audio signal is translated between the second language and the third language. And further, the second audio signal is generated using a speech synthesis model associated with the third language.

Some embodiments involve re-translating the transcription and then generating a third audio signal from the re-translation. Next, the third audio signal generated from re-translating the transcription of the first audio signal received from the first client communication device is communicated to the second client communication device. Then (i) the first audio signal received from the first device, (ii) the second audio signal generated from the translation of the transcription of the first audio signal received from the first client communication device, and (iii) the third audio signal generated from re-translating the transcription of the first audio signal received from the first client communication device, are communicated to a third client communication device.

In some embodiments, the communication of the first audio signal is staggered with the communication of the second audio signal. Certain embodiments include establishing a Voice Over Internet Protocol (VOIP) connection between the first client communication device and the second client communication device. And some embodiments involve communicating, to the first client communication device, (i) the first audio signal received from the first device, and (ii) the second audio signal generated from the translation of the transcription of the first audio signal received from the first client communication device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1, 4, 5, and 6 illustrate exemplary systems for performing automatic translation of speech,

FIGS. 2A to 2C illustrate exemplary user interfaces.

FIG. 3 illustrates an exemplary process.

Like reference numbers represent corresponding parts throughout.

### DETAILED DESCRIPTION

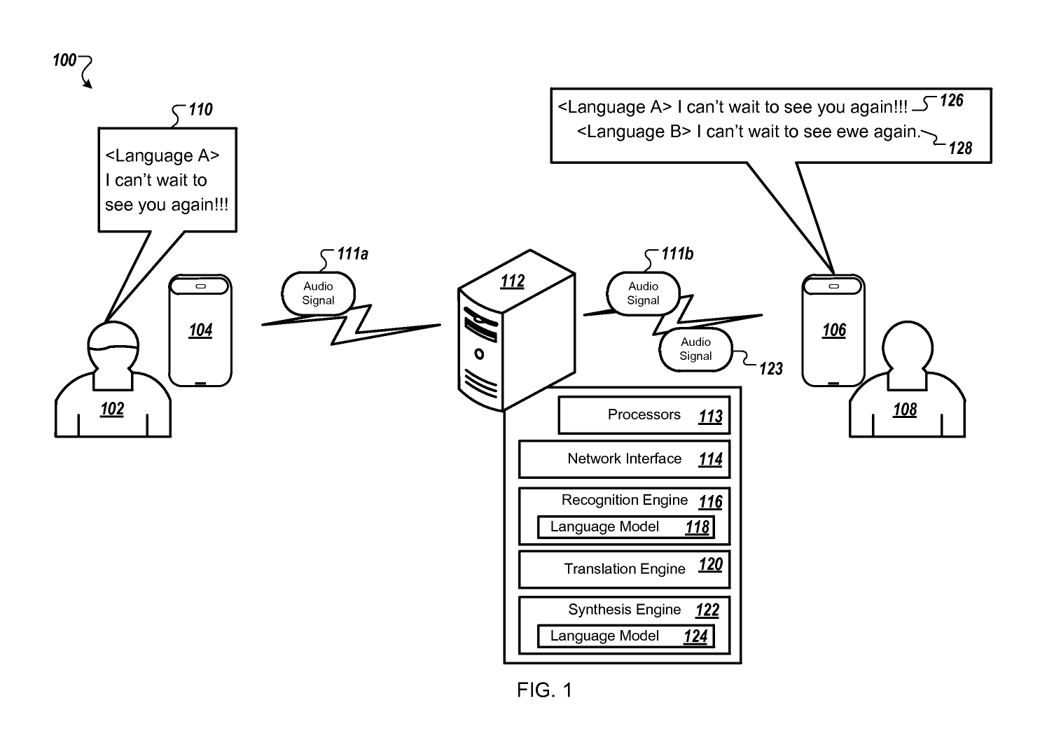

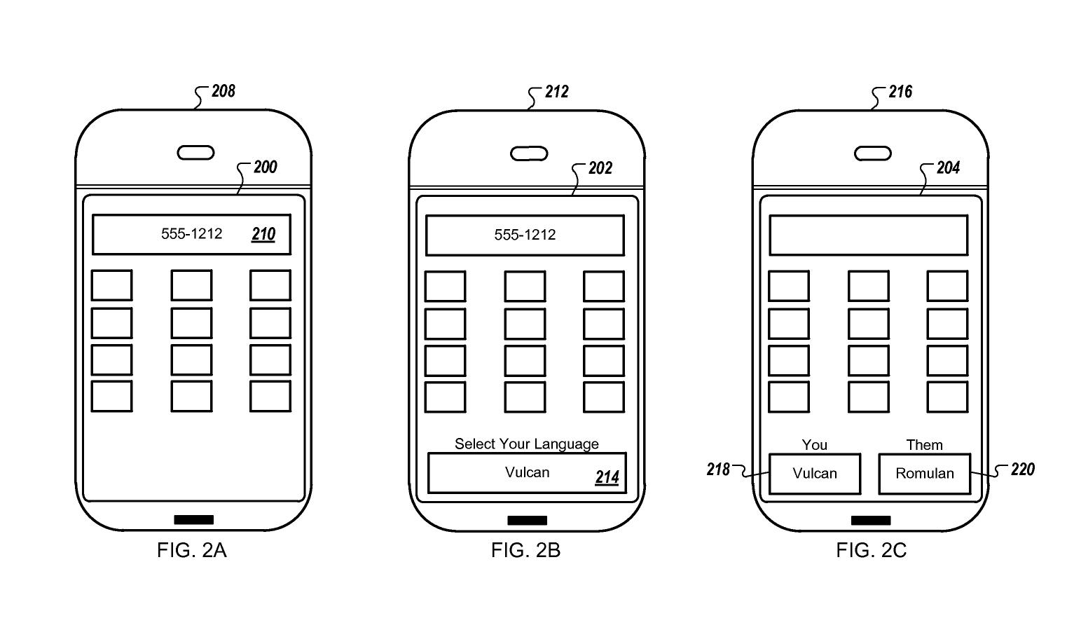

FIG. 1 illustrates an exemplary system 100 for performing automatic translation of speech. A user 102 uses a mobile device 104 to call a mobile device 106 of a user 108. The user 102 and the user 108 speak different languages. For example, the user 102 may be an American who speaks English and the user 108 may be a Spaniard who speaks Spanish. The user 102 may have met the user 108 while taking a trip in Spain and may want to keep in touch after the trip. Before or as part of placing the call, the user 102 may select English as her language and may select Spanish as the language of the user 108. As described in more detail below with respect to FIGS. 2A-2C, other language setup approaches may be used.

In general, the conversation between the users 102 and 108 may be translated as if a live translator were present on the telephone call. For example, a first audio signal 111a may be generated when the first user 102 speaks into the mobile device 104, in English. A transcription of the first audio signal 111a may be generated, and the transcription may be translated into Spanish. A translated audio signal 111b, including words translated in Spanish may be generated from the translation. The first audio signal 111a may be communicated to the mobile device 106 of the second user 108, to allow the second user 108 to hear the first user's voice. The translated audio signal 111b may also be communicated, to allow the second user 108 to also hear the translation.

In more detail, the user 102 speaks words 110 (e.g., in “Language A”, such as English) into the mobile device 104. An application running on the mobile device 104 may detect the words 110 and may send an audio signal 111a corresponding to the words 110 to a server 112, such as over one or more networks. The server 112 includes one or more processors 113. The processors 113 may include any appropriate processor and/or logic that is capable of receiving and storing data, and of communicating over the one or more networks using a network interface 114. The processors 113 may execute one or more computer programs.

For example, a recognition engine 116 may receive the audio signal 111a and may convert the audio signal 111a into text in “Language A”. The recognition engine 116 may include subroutines for recognizing words, parts of speech, etc. For example, the recognition engine 116 may include a speech segmentation routine for breaking sounds into sub-parts and using those sub-parts to identify words, a word disambiguation routine for identifying meanings of words, a syntactic lexicon to identify sentence structure, parts-of-speech, etc., and a routine to compensate for regional or foreign accents in the user's language. The recognition engine 116 may use a language model 118.

The text output by the recognition engine 116 may be, for example, a file containing text in a self-describing computing language, such as XML (eXtensible Markup Language). Self-describing computing languages may be useful in this context because they enable tagging of words, sentences, paragraphs, and grammatical features in a way that is recognizable to other computer programs. Thus, another computer program, such as a translation engine 120, can read the text file, identify, e.g., words, sentences, paragraphs, and grammatical features, and use that information as needed.

For example, the translation engine 120 may read the text file output by the recognition engine 116 and may generate a text file for a pre-specified target language (e.g., the language of the user 108). For example, the translation engine 120 may read an English-language text file and generate a Spanish-language text file based on the English-language text file. The translation engine 120 may include, or reference, an electronic dictionary that correlates a source language to a target language.

The translation engine 120 may also include, or reference, a syntactic lexicon in the target language to modify word placement in the target language relative to the native language, if necessary. For example, in English, adjectives typically precede nouns. By contrast, in some languages, such as French, (most) adjectives follow nouns. The syntactic lexicon may be used to set word order and other grammatical features in the target language based on, e.g., tags included in the English-language text file. The output of the translation engine 120 may be a text file similar to that produced by the recognition engine 116, except that it is in the target language. The text file may be in a self-describing computer language, such as XML.

A synthesis engine 122 may read the text file output by the translation engine 120 and may generate an audio signal 123 based on text in the text file. The synthesis engine 122 may use a language model 124. Since the text file is organized according to the target language, the audio signal 123 generated is for speech in the target language.

The audio signal 123 may be generated with one or more indicators to synthesize speech having accent or other characteristics. The accent may be specific to the mobile device on which the audio signal 123 is to be played (e.g., the mobile device 106). For example, if the language conversion is from French to English, and the mobile device is located in Australia, the synthesis engine 122 may include an indicator to synthesize English-language speech in an Australian accent.

The server 112 may communicate the audio signal 111a to the mobile device 106 (e.g., as illustrated by an audio signal 111b). For example, the server 122 can establish a telephone connection between the mobile device 104 and the mobile device 106. As another example, the server 122 can establish a Voice Over Internet Protocol (VOIP) connection between the mobile device 104 and the mobile device 106. The server 122 can also communicate the audio signal 123 to the mobile device 106.

The communication of the audio signal 111b may be staggered with the communication of the audio signal 123. For example, words 126 and words 128 illustrate the playing of the audio signal 111b followed by the audio signal 123, respectively, on the mobile device 106. The staggering of the audio signal 11b and the audio signal 123 can result in multiple benefits.

For example, the playing of the audio signal 111b followed by the audio signal 123 may an experience for the user 108 similar to a live translator being present. The playing of the audio signal 111a for the user 108 allows the user 108 to hear the tone, pitch, inflection, emotion, and the speed of the speaking of the user 102. For example, the user 108 can hear the emotion of the user 102 as illustrated by the exclamation points included in the words 126.

As another example, the user 108 may know at least some of the language spoken by the user 102 and may be able to detect a translation error after hearing the audio signal 111a followed by the audio signal 123. For example, the user 108 may be able to detect a translation error that occurred when the word “ewe” included in the words 128 was generated. In some implementations, the audio signal 123 is also sent to the mobile device 104, so that the user 102 can hear the translation. The user 102 may, for example, recognize the translation error related to the generated word “ewe”, if the user 102 knows at least some of the language spoken by the user 108.

Although the system 100 is described above as having speech recognition, translation, and speech synthesis performed on the server 112, some or all of the speech recognition, translation, and speech synthesis may be performed on one or more other devices. For example, one or more other servers may perform some or all of one or more of the speech recognition, the translation, and the speech synthesis. As another example, some or all of one or more of the speech recognition, the translation, and the speech synthesis may be performed on the mobile device 104 or the mobile device 106.

FIGS. 2A-2C illustrate exemplary user interfaces 200-204, respectively, for configuring one or more languages for a translation application. As shown in FIG. 2A, the user interface 200 is displayed on a mobile device 208 and includes a call control 210. The user can use the call control 210, for example, to enter a telephone number to call.

The user can indicate that they desire a translation application to translate audio signals associated with the call, for example by selecting a control (not shown) or by speaking a voice command. In response to the user launching the translation application, the translation application can prompt the user to select a language. As another example, the translation application can automatically detect the language of the user of the mobile device 208 upon the user speaking into the mobile device 108. As another example, a language may already be associated with the mobile device 108 or with the user of the mobile device 108 and the translation application may use that language for translation without prompting the user to select a language.

The user interface 202 illustrated in FIG. 2B may be displayed on a mobile device 212 if the translation application is configured to prompt the user for a language to use for translation. The user interface 202 includes a control 214 for selecting a language. The user may select a language, for example, from a list of supported languages. As another example, the user may select a default language. The default language may be the language that is spoken at the current geographic location of the mobile device 212. For example, if the mobile device is located in the United States, the default language may be English. As another example, the default language may be a language that has been previously associated with the mobile device 212.

In some implementations, the translation application prompts the user to enter both their language and the language of the person they are calling. In some implementations, a translation application installed on a mobile device of the person being called prompts that user to enter their language (and possibly the language of the caller). As mentioned above, the language of the user of the mobile device 212 may be automatically detected, such as after the user speaks into the mobile device 212, and a similar process may be performed on the mobile device of the person being called to automatically determine the language of that user. One or both languages may be automatically determined based on the geographic location of the respective mobile devices.

The user interface 204 illustrated in FIG. 2C may be displayed on a mobile device 216 if the translation application is configured to prompt the user to enter both their language and the language of the person they are calling. For example, the user may use a control 218 to select their language and may use a control 220 to select the language of the user they are calling. As described above, the user may select a default language for their language and/or for the language of the person they are calling.

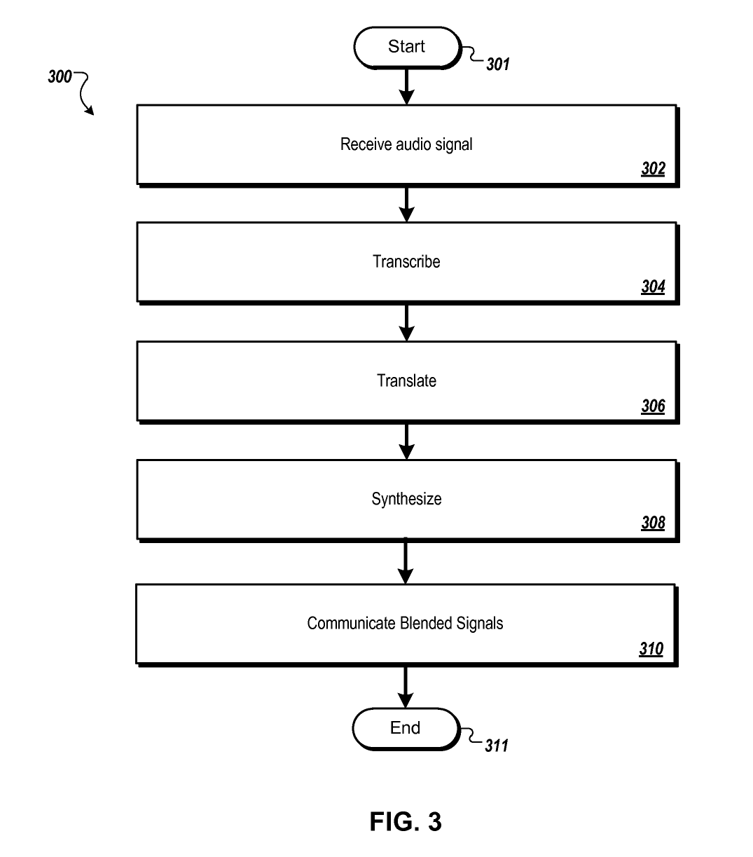

FIG. 3 is a flowchart illustrating a computer-implemented process 300 for translation. When the process 300 begins (S301), a first audio signal is received from a first client communication device (S302). The first client communication device may be, for example, a mobile device (e.g., a smart phone, personal digital assistant (PDA), BlackBerry™, or other mobile device), a laptop, a desktop, or any other computing device capable of communicating using the IP (Internet Protocol). The first audio signal may correspond, for example, to a user speaking into the first client communication device (e.g., the user may speak into the first client communication device after the first client communication device has established a telephone connection). As another example, the user may speak into the first client communication device when the first client communication device is connected to a video conference system. As yet another example, the first audio signal may correspond to computer-generated speech generated by the first client communication device or by another computing device.

Along with receiving a first audio signal, data identifying a first language associated with the first audio signal may also be received from the first client communication device. For example, the user may select a language using an application executing on the first client communication device and data indicating the selection may be provided. As another example, an application executing on the first client communication device may automatically determine a language associated with the first audio signal and may provide data identifying the language.

A transcription of the first audio signal is generated (S304). For example, the transcription may be generated by a speech recognition engine. The speech recognition engine may use, for example, a language model associated with the first language to generate the transcription. In some implementations, a signal indicating that the first audio signal is complete is received from the first client communication device and the transcription of the first audio signal is generated only after receiving the signal indicating that the first audio signal is complete.

The transcription is translated (S306). The transcription may be translated, for example, using a translation engine. The transcription may be translated from the first language to a second language. In some implementations, data identifying the second language may be received with the first audio signal. For example, the user of the first client communication device may select the second language. As another example, a user of a second client communication device may speak into the second client communication device and the second language may be automatically identified based on the speech of the user of the second client communication device and an identifier of the second language may be received, such as from the second client communication device.

A second audio signal is generated from the translation (S308), such as by using a speech synthesis model associated with the second language. For example, a speech synthesizer may generate the second audio signal.

The first audio signal received from the first device and the second audio signal generated from the translation of the transcription of the first audio signal received from the first client communication device are communicated to the second client communication device (S310), thereby ending the process 300 (S311). Before communicating the first audio signal, a telephone connection, for example, may be established between the first client communication device and the second client communication device. As another example, a VOIP connection may be established between the first client communication device and the second client communication device.

The communication of the first audio signal may be staggered with the communication of the second audio signal. For example, in some implementations, the sending of the first audio signal is initiated and the sending of the second audio signal is initiated while the first audio signal is still being sent. In some implementations, the sending of the second audio signal is initiated after the sending of the first audio signal has been completed. In some implementations, some or all of one or more of the transcribing, the translating, and the speech synthesis may be performed while the first audio signal is being sent. Staggering the communication of the first audio signal with the communication of the second audio signal may allow the user of the second client communication device to hear initial (e.g., untranslated) audio followed by translated audio, which may be an experience similar to hearing a live translator perform the translation. In some implementations, a voice-over effect may be created on the second client communication device by the second client communication device playing at least some of the second audio signal while the first audio signal is being played.

In some implementations, the first audio signal and the second audio signal are communicated to the first client communication device. Communicating both the first audio signal and the second audio signal to the first client communication device may allow the user of the first client communication device to hear both a playback of their spoken words and the corresponding translation (that is, if the first audio signal corresponds to the user of the first client communication device speaking into the first client communication device). In some implementations, the second audio signal is communicated to the first client communication device but not the first audio signal. For example, the user of the first client communication device may be able to hear themselves speak the first audio signal (e.g., locally), and accordingly the first audio signal might not be communicated to the first client communication device, but the second audio signal may be communicated to allow the user of the first client communication device to hear the translated audio.

In some implementations, more than two client communication devices may be used. For example, the first and second audio signals may be communicated to multiple client communication devices, such as if multiple users are participating in a video or voice conference. As another example, a third client communication device may participate along with the first and second client communication devices. For example, suppose that the user of the first client communication device speaks English, the user of the second client communication device speaks Spanish, and a user of the third client communication device speaks Chinese. Suppose also that the three users are connected in a voice conference.

In this example, along with communicating the first audio signal and the second audio signal to the second client communication device (e.g., where the first audio signal is in English and the second audio signal is in Spanish), the transcription may be retranslated (e.g., into a third language, such as Chinese) and a third audio signal may be generated from the re-translation. The third audio signal may be communicated to the first, second, and third client communication devices (the first audio signal and the second audio signal may also be communicated to the third client communication device). In other words, in a group of three (or more) users, an initial audio signal associated with the language of one user may be converted into multiple audio signals, where each converted audio signal corresponds to a language of a respective, other user and is communicated, along with the initial audio signal, to at least the respective, other user.

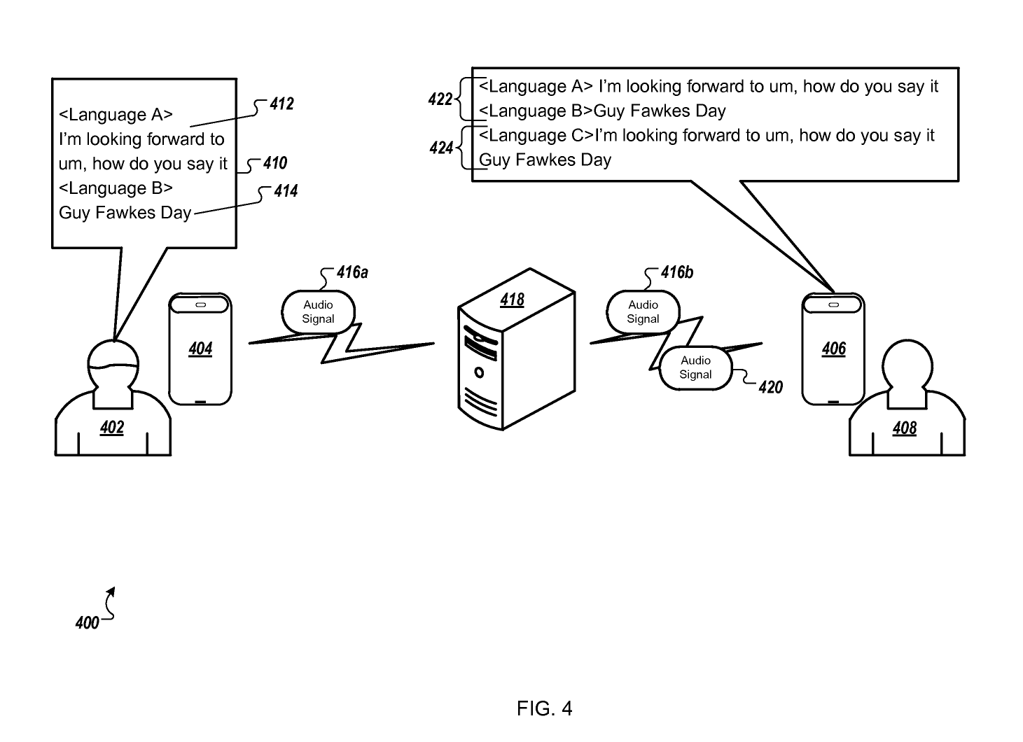

FIG. 4 illustrates an exemplary system 400 for performing automatic translation of speech. A user 402 uses a mobile device 404 to call a mobile device 406 of a user 408, where the user 402 and the user 408 speak different languages. The user 402 speaks words 410 into the mobile device 404. The words 410 include words 412 in a first language (e.g., “Language A”) and words 414 in a second language (e.g., “Language B”).

An application running on the mobile device 404 may detect the words 410 and may send an audio signal 416a corresponding to the words 410 to a server 418. A recognition engine included in the server 418 may receive the audio signal 416a and may convert the audio signal 416a into text. The recognition engine may automatically detect the “Language A” and the “Language B” and may convert both a portion of the audio signal 416a that corresponds to the words 412 in “Language A” to text in “Language A” and may convert a portion of the audio signal 416a that corresponds to the words 414 in “Language B” to text in “Language B” using, for example, a language model for “Language A” and a language model for “Language B”, respectively.

A translation engine included in the server 418 may convert both the “Language A” text and the “Language B” text generated by the recognition engine to text in a “Language C” that is associated with the user 408. A synthesis engine included in the server 418 may generate an audio signal 420 in “Language C” based on the text generated by the translation engine, using, for example, a synthesis model associated with “Language C”.

The server 418 may communicate the audio signal 416a to the mobile device 406 (e.g., as illustrated by an audio signal 416b). The audio signal 416b may be played on the mobile device 406, as illustrated by words 422. The server 420 may send the audio signal 420 to the mobile device 406, for playback on the mobile device 406, as illustrated by words 424. The words 424 are all in the “Language C”, even though the words 410 spoken by the user 402 are in both “Language A” and “Language B”. As discussed above, the audio signal 416a may be played first, followed by the audio signal 420, allowing the user 408 to hear both the untranslated and the translated audio.

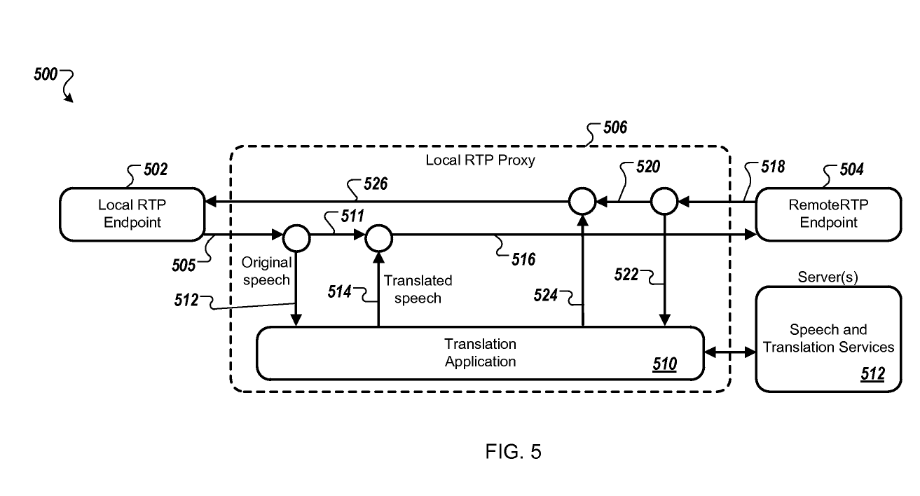

FIG. 5 illustrates an exemplary system 500 for performing automatic translation of speech. The system 500 includes a local RTP (Real-time Transport Protocol) endpoint 502 and one or more remote RTP endpoints 504. The local RTP endpoint 502 and the remote RTP endpoint 504 may each be, for example, a mobile device (e.g., a smart phone, personal digital assistant (PDA), BlackBerry™, or other mobile device), a laptop, a desktop, or any other computing device capable of communicating using the IP (Internet Protocol). The local RTP endpoint 502 may be, for example, a smartphone that is calling the remote RTP endpoint 504, where the remote RTP endpoint 504 is a POTS (“Plain Old Telephone Service) phone. As another example, the local RTP endpoint 502 and multiple remote RTP endpoints 504 may each be associated with users who are participating in a voice or video chat conference.

An audio signal 505 is received by a local RTP proxy 506. The local RTP proxy 506 may be installed, for example, on the local RTP endpoint 502. The local RTP proxy 506 includes a translation application 510. The audio signal 505 may be received, for example, as a result of the local RTP proxy 506 intercepting voice data, such as voice data associated with a call placed by the local RTP endpoint 502 to the remote RTP endpoint 504. The audio signal 505 may be split, with a copy 511 of the audio signal 505 being sent to the remote RTP endpoint 504 and a copy 512 of the audio signal 505 being sent to the translation application 510.

The translation application 510 may communicate with one or more servers 513 to request one or more speech and translation services. For example, the translation application 510 may send the audio signal 512 to the server 513 to request that the server 513 perform speech recognition on the audio signal 512 to produce text in the same language as the audio signal 512. A translation service may produce text in a target language from the text in the language of the audio signal 512. A synthesis service may produce audio in the target language (e.g., translated speech, as illustrated by an arrow 514). The translation application may insert the translated speech into a communication stream (represented by an arrow 516) that is targeted for the remote RTP endpoint 504.

Translation can also work in a reverse pattern such as when an audio signal 518 is received by the local RTP proxy 506 from the remote RTP endpoint 504. In this example, the local RTP proxy 506 may be software that is installed on the remote RTP endpoint 504 that is “local” from the perspective of the remote RTP endpoint 504. The local RTP endpoint 506 may intercept the audio signal 518 and a copy 520 of the audio signal 518 may be sent to the local RTP endpoint 502 and a copy 522 of the audio signal 518 may be sent to the translation application 510. The translation application 510 may, using services of the servers 512, produce translated speech 524, which may be inserted into a communication stream 526 for communication to the local RTP endpoint 502.

In some implementations, the translation application 510 is installed on both the local RTP endpoint 502 and on the remote RTP endpoint 504. In some implementations, the translation application 510 includes a user interface which includes a “push to talk” control, where the user of the local RTP endpoint 502 or the remote RTP endpoint 504 selects the control before speaking. In some implementations, the translation application 510 automatically detects when the user of the local RTP endpoint 502 or the user of the remote RTP endpoint 504 begins and ends speaking, and initiates transcription upon detecting a pause in the speech. In some implementations, the translation application 510 is installed on one but not both of the local RTP endpoint 502 and the remote RTP endpoint 504. In such implementations, the one translation application 510 may detect when the other user begins and ends speech and may initiate transcription upon detecting a pause in the other user's speech.

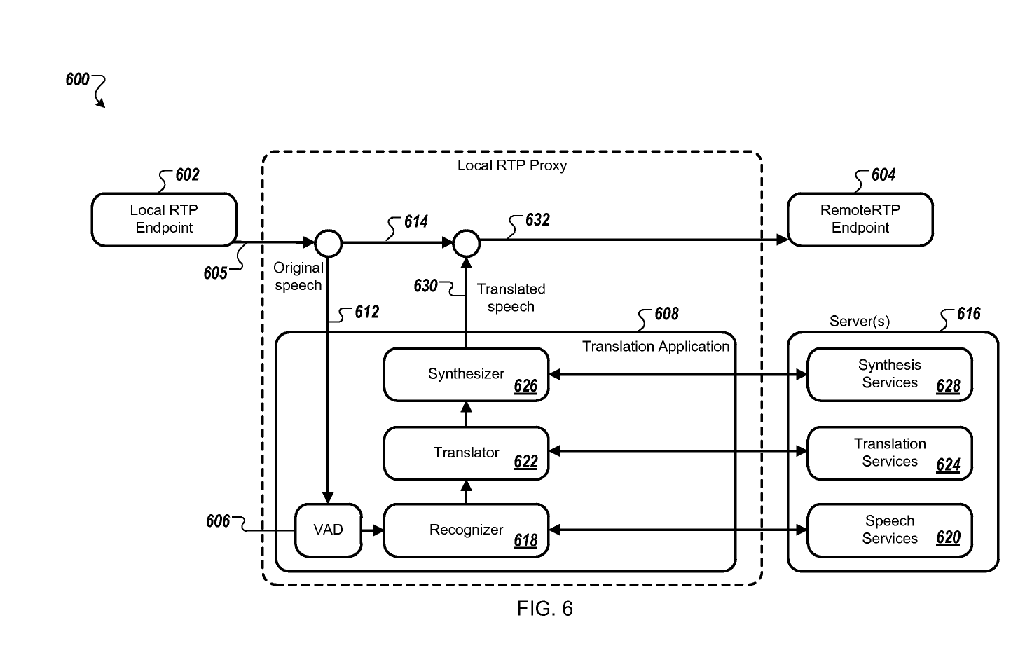

In further detail, FIG. 6 illustrates an exemplary system 600 for translation. The system 600 includes a local RTP endpoint 602 and a remote RTP endpoint 604. The local RTP endpoint 602 generates an audio signal 605 (e.g., corresponding to a user speaking into a mobile device). A VAD (Voice Activity Detection) component 606 included in a translation application 608 detects the audio signal 605, as illustrated by an audio signal 612. The audio signal 605 may be split, with the audio signal 612 being received by the VAD component 606 and a copy 614 of the audio signal 605 being sent to the remote RTP endpoint 604.

The translation application 608 may communicate with one or more servers 616 to request one or more speech and translation services. For example, a recognizer component 618 may receive the audio signal 612 from the VAD component 606 and may send the audio signal 612 to a speech services component 620 included in the server 616. The speech services component 616 may perform speech recognition on the audio signal 612 to produce text in the same language as the audio signal 612. A translator component 622 may request a translation services component 624 to produce text in a target language from the text in the language of the audio signal 612. A synthesizer component 626 may request a synthesis services component 628 to produce audio in the target language. The synthesizer component 626 may insert the audio (e.g., as translated speech 630) into a communication stream (represented by an arrow 632) that is targeted for the remote RTP endpoint 604.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the invention may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the invention may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the invention, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments of the invention have been described. Other embodiments are within the scope of the following claims. For example, the actions recited in the claims may be performed in a different order and still achieve desirable results.

What is claimed is:

1. A computer-implemented method comprising:
receiving a first audio signal from a first client communication device associated with a first user;
generating a transcription of the first audio signal;
translating the transcription;
generating a second audio signal from the translation; and
communicating, to a second client communication device associated with a second user, a blended signal comprising (i) the first audio signal received from the first device, and (ii) the second audio signal generated from the translation of the transcription of the first audio signal received from the first client communication device, the blended signal including the first audio signal and the second audio signal being communicated for output at the second client communication device to the second user.

2. The computer-implemented method of claim 1, comprising:
receiving data identifying a language associated with the first audio signal from the first client communication device.

3. The computer-implemented method of claim 1, comprising:
receiving data identifying a language associated with the second audio signal from the first client communication device.

4. The computer-implemented method of claim 1, wherein communicating the first audio signal and the second audio signal comprises sending the first audio signal, and sending the second audio signal while the first audio signal is still being sent.

5. The computer-implemented method of claim 1, comprising establishing a telephone connection between the first client communication device and the second client communication device.

6. The computer-implemented method of claim 1, comprising receiving from the first client communication device a signal indicating that the first audio signal is complete, wherein the transcription of the first audio signal is generated only after receiving the signal indicating that the first audio signal is complete.

7. The computer-implemented method of claim 1, comprising automatically determining a first language associated with the first audio signal and a second language associated with the second audio signal,
wherein the transcription is generated using a language model associated with the first language,
wherein the transcription is translated between the first language and the second language, and
wherein the second audio signal is generated using a speech synthesis model associated with the second language.

8. The computer-implemented method of claim 1, comprising automatically determining a first language associated with a first portion of the first audio signal, a second language associated with a second portion of the first audio signal, and a third language associated with the second audio signal,
wherein the transcription of the first portion of the first audio signal is generated using a language model associated with the first language,
wherein the transcription of the second portion of the first audio signal is generated using a language model associated with the second language,
wherein the transcription of the first portion of the first audio signal is translated between the first language and the third language,
wherein the transcription of the second portion of the audio signal is translated between the second language and the third language, and
wherein the second audio signal is generated using a speech synthesis model associated with the third language.

9. The computer-implemented method of claim 1, comprising:
re-translating the transcription;
generating a third audio signal from the re-translation;
communicating, to the second client communication device, the third audio signal generated from re-translating the transcription of the first audio signal received from the first client communication device; and
communicating, to a third client communication device, (i) the first audio signal received from the first device, (ii) the second audio signal generated from the translation of the transcription of the first audio signal received from the first client communication device, and (iii) the third audio signal generated from re-translating the transcription of the first audio signal received from the first client communication device.

10. The computer-implemented method of claim 1, wherein the communication of the first audio signal is staggered with the communication of the second audio signal.

11. The computer-implemented method of claim 1, comprising establishing a Voice Over Internet Protocol (VOIP) connection between the first client communication device and the second client communication device.

12. The computer-implemented method of claim 1, comprising communicating, to the first client communication device, (i) the first audio signal received from the first device, and (ii) the second audio signal generated from the translation of the transcription of the first audio signal received from the first client communication device.

13. A system comprising:
one or more computers and one or more storage devices storing instructions that are operable, when executed by the one or more computers, to cause the one or more computers to perform operations comprising:
receiving a first audio signal from a first client communication device associated with a first user;
generating a transcription of the first audio signal;
translating the transcription;
generating a second audio signal from the translation; and
communicating, to a second client communication device associated with a second user, a blended signal comprising (i) the first audio signal received from the first device, and (ii) the second audio signal generated from the translation of the transcription of the first audio signal received from the first client communication device, the blended signal including the first audio signal and the second audio signal being communicated for output at the second client communication device to the second user.

14. The system of claim 13, comprising:
receiving data identifying a language associated with the first audio signal from the first client communication device.

15. The system of claim 13, comprising receiving from the first client communication device a signal indicating that the first audio signal is complete, wherein the transcription of the first audio signal is generated only after receiving the signal indicating that the first audio signal is complete.

16. The system of claim 13, comprising automatically determining a first language associated with the first audio signal and a second language associated with the second audio signal,
wherein the transcription is generated using a language model associated with the first language,
wherein the transcription is translated between the first language and the second language, and
wherein the second audio signal is generated using a speech synthesis model associated with the second language.

17. The system of claim 13, comprising automatically determining a first language associated with a first portion of the first audio signal, a second language associated with a second portion of the first audio signal, and a third language associated with the second audio signal,
wherein the transcription of the first portion of the first audio signal is generated using a language model associated with the first language,
wherein the transcription of the second portion of the first audio signal is generated using a language model associated with the second language,
wherein the transcription of the first portion of the first audio signal is translated between the first language and the third language,
wherein the transcription of the second portion of the audio signal is translated between the second language and the third language, and
wherein the second audio signal is generated using a speech synthesis model associated with the third language.

18. The system of claim 13, comprising:
re-translating the transcription;
generating a third audio signal from the re-translation;
communicating, to the second client communication device, the third audio signal generated from re-translating the transcription of the first audio signal received from the first client communication device; and
communicating, to a third client communication device, (i) the first audio signal received from the first device, (ii) the second audio signal generated from the translation of the transcription of the first audio signal received from the first client communication device, and (iii) the third audio signal generated from re-translating the transcription of the first audio signal received from the first client communication device.

19. The system of claim 13, comprising communicating, to the first client communication device, (i) the first audio signal received from the first device, and (ii) the second audio signal generated from the translation of the transcription of the first audio signal received from the first client communication device.

20. A non-transitory computer-readable medium storing software comprising instructions executable by one or more computers which, upon such execution, cause the one or more computers to perform operations comprising:
receiving a first audio signal from a first client communication device associated with a first user;
generating a transcription of the first audio signal;
translating the transcription;
generating a second audio signal from the translation; and
communicating, to a second client communication device associated with a second user, a blended signal comprising (i) the first audio signal received from the first device, and (ii) the second audio signal generated from the translation of the transcription of the first audio signal received from the first client communication device, the blended signal including the first audio signal and the second audio signal being communicated for output at the second client communication device to the second user.

21. The non-transitory computer-readable medium of claim 20, comprising receiving from the first client communication device a signal indicating that the first audio signal is complete, wherein the transcription of the first audio signal is generated only after receiving the signal indicating that the first audio signal is complete.

22. The non-transitory computer-readable medium of claim 20, comprising automatically determining a first language associated with the first audio signal and a second language associated with the second audio signal,
wherein the transcription is generated using a language model associated with the first language,
wherein the transcription is translated between the first language and the second language, and
wherein the second audio signal is generated using a speech synthesis model associated with the second language.

23. The non-transitory computer-readable medium of claim 20, comprising automatically determining a first language associated with a first portion of the first audio signal, a second language associated with a second portion of the first audio signal, and a third language associated with the second audio signal,
wherein the transcription of the first portion of the first audio signal is generated using a language model associated with the first language,
wherein the transcription of the second portion of the first audio signal is generated using a language model associated with the second language,
wherein the transcription of the first portion of the first audio signal is translated between the first language and the third language,
wherein the transcription of the second portion of the audio signal is translated between the second language and the third language, and
wherein the second audio signal is generated using a speech synthesis model associated with the third language.

24. The non-transitory computer-readable medium of claim 20, comprising:
re-translating the transcription;
generating a third audio signal from the re-translation;
communicating, to the second client communication device, the third audio signal generated from re-translating the transcription of the first audio signal received from the first client communication device; and
communicating, to a third client communication device, (i) the first audio signal received from the first device, (ii) the second audio signal generated from the translation of the transcription of the first audio signal received from the first client communication device, and (iii) the third audio signal generated from re-translating the transcription of the first audio signal received from the first client communication device.

25. The non-transitory computer-readable medium of claim 20, comprising communicating, to the first client communication device, (i) the first audio signal received from the first device, and (ii) the second audio signal generated from the translation of the transcription of the first audio signal received from the first client communication device.
